(19) United States
(12) Patent Application Publication
(10) Pub. No.: US 2024/0202587 A1
(43) Pub. Date: Jun. 20, 2024

(54) UN-LEARNING OF TRAINING DATA FOR MACHINE LEARNING MODELS

(71) Applicant: Amazon Technologies, Inc., Reno, NV (US)

(72) Inventors: Vinayshekhar Bannihatti Kumar, Santa Clara, CA (US); Rashmi Gangadharaiah, San Jose, CA (US); Dan Roth, Philadelphia, PA (US)

(21) Appl. No.: 18/344,419

(22) Filed: Jun. 29, 2023

Related U.S. Application Data
(60) Provisional application No. 63/387,590, filed on Dec. 15, 2022.

(51) Int. Cl. G06N 20/00

(52) U.S. Cl. CPC G06N 20/00

(57) ABSTRACT

Methods and systems are disclosed for a machine learning (ML) model training system that can remove the influence of specific data points in an efficient way. An ML training system can train multiple instances of a machine learning model on disjoint shards of data. Upon receiving a request to remove a specific data point, the ML training system can expunge the data point from its corresponding shard and only retrain the model instance for that specific shard. Each shard can be further divided into data slices, with each slice containing a portion of the data from the shard. During the training of each instance of the machine learning model, the ML training system can save model checkpoints after completion of training for each slice. Upon receiving a removal request, the related data point is removed from its respective slice, and the relevant model instance can be retrained starting from the last checkpoint before that slice had been previously used for training.

### CROSS-REFERENCE TO RELATED APPLICATIONS

This application claims priority to U.S. Provisional Patent Application Ser. No. 63/387,590, filed Dec. 15, 2022, and entitled “Privacy Adhering ML training in NLP,” which is hereby incorporated herein in its entirety and for all purposes.

### BACKGROUND

There has recently been a drastic expansion and adoption of artificial intelligence (AI) and machine learning (ML) models across a wide variety of industries for use in performing an ever-increasing array of tasks. ML models are typically trained on vast amounts of data to provide predictions, recommendations, and other types of decision-making assistance. While these developments have been beneficial, the including of large amounts of training data that can be obtained from various sources has also raised serious concerns regarding privacy and security of the data used to train these models. Current data privacy laws, such as the General Data Protection Regulation (GDPR) in the European Union and the California Consumer Privacy Act (CCPA) in the United States, include provisions on the right to be forgotten, which enables individuals to request the removal or deletion of their personal data. The provisions mandate industry applications to remove the influence of specific data points, as can be related to an individual, from a system of the industry. In many existing approaches, each such request can require identifying and removing the data from a training data set, then retraining an entire model from scratch without the removed data. Compliance with frequent data removal requests can thus be difficult to satisfy, particularly for smaller companies with limited budget that rely on large data models, such as language models used for natural language processing (NLP).

### BRIEF DESCRIPTION OF THE DRAWINGS

Various embodiments in accordance with the present disclosure will be described with reference to the drawings, in which:

FIG. 1 illustrates a system environment including a ML training system which can be used in accordance with various embodiments.

FIG. 2 illustrates an example ML training system, in accordance with various embodiments.

FIG. 3 illustrates an example embodiment for processing data, in accordance with various embodiments.

FIG. 4 illustrates an example embodiment for saving models at checkpoints, in accordance with various embodiments.

FIG. 5 illustrates an example framework of a ML training process, in accordance with various embodiments.

FIG. 6 illustrates an example process for removing a data point from a trained machine learning model, in accordance with various embodiment.

FIG. 7 illustrates an example network-inclusive computing environment in which aspects of various embodiments can be implemented.

FIG. 8 illustrates example components of a server that can be utilized to perform at least a portion of a network management process, in accordance with various embodiments.

FIG. 9 illustrates example components of a computing device that can be used to implement network monitoring and management aspects of various embodiments.

### DETAILED DESCRIPTION

Approaches described and suggested herein relate to the training and retraining of machine learning models. Specifically, methods and systems are disclosed for ML training, and retraining, wherein the influence of one or more specific data points can be “forgotten” or “un-learned” buy a machine learning (ML) model in an efficient way that conserves memory, time, and space resources with respect to retraining of an entire model. An ML training system (or module or process, etc.) can train multiple instances of a machine learning model using a set of training data, where each instance is trained on a different subset of that training data. Individual subsets of training data will be referred to herein as shards. Each shard can also be broken down into a number of further subsets, referred to herein as slices. During training, checkpoints can be registered after use of the data in each slice of a shard. It might be the case that a request is received to remove a specific data point (or set of data points) from the training data set, as well as any influence or related “learnings” of the ML instances. Upon receiving such a request, a shard can be identified that includes the specified data point(s), as well as the slice(s) that contains the specified data point(s). The data point(s) can be removed from the slice(s) of the shard. The ML instance corresponding to that shard can then be retrained, but only from the last checkpoint logged before prior training using the removed slice(s). In this way, the other ML instances do not need to be retrained, significantly reducing an amount of training that would otherwise need to be performed if a single, large model were used rather than a number of model instances. Further, the training of the individual model instance does not need to be completely re-preformed from scratch, but only from the checkpoint in the training before the removed data point, such that any parameter or weight updates to the model during training up to that point can be used as a starting point for retraining, further reducing the necessary amount of retraining. In at least one embodiment, data that is more likely to be subject to a removal request can be placed at slices to be used later in the training process, to further reduce the amount of retraining to be performed by reducing the number of slices required to be used for the retraining for a given request.

An ML training system, service, or process as disclosed herein can provide a number of technical advantages. For example, the ML training system can remove requested data points in a computational efficient manner. Unlike traditional methods where an entire model needs to be retrained to remove a single data point, which can be time-consuming and resource-intensive, an ML training system can significantly streamline this process. The ML training system can divide a full dataset into smaller subsets such as shards and slices. When a request for data removal is received, the system can identify the shard and slice containing the particular data point. Instead of retraining a single large model using the complete dataset, the system only retrains the instance corresponding to the specific shard, using slices of data within that shard. By localizing the area of impact to a specific shard or slice(s), such an approach can reduce the amount of data for which retraining needs to be performed, thereby increasing a speed and efficiency of the retraining (or “un-learning”) process and decreasing the amount of computational resource capacity required, as can include processing power and memory.

Additionally, an ML training system as disclosed herein can ensure that the requested data to be removed is completely expunged, a significant improvement over existing methods that can only assure (potentially with a certain probability) that a user's data has been forgotten or cannot be inferred. The ML training system can remove data points without causing substantial degradation to the model's performance, a phenomenon referred to as “catastrophic unlearning.” Such an ML training system can offer a robust and efficient solution, ensuring the complete and irrevocable removal of specified data, thereby aligning with data privacy norms without compromising performance of the machine learning model.

Furthermore, such an ML training system can efficiently scale, even when faced with a high frequency of data removal requests. In various real-world industry applications, machine learning models are employed to construct models based on user data and user information. As a consequence, if such applications receive data removal requests at a high frequency, the cycle of data elimination and model retraining does not scale effectively. Maintaining the performance of the models trained on user data becomes a significant challenge, given the scale at which they operate. The process of efficiently removing data while providing complete removal guarantees becomes exceedingly time-consuming and costly. In contrast, the ML training system, with its efficient data handling and model retraining approach, offers a scalable solution capable of managing high-frequency data removal requests while ensuring model performance and guaranteeing complete data removal.

In the following description, various embodiments will be described. For purposes of explanation, specific configurations and details are set forth in order to provide a thorough understanding of the embodiments. However, it will also be apparent to one skilled in the art that the embodiments can be practiced without the specific details. Furthermore, well-known features can be omitted or simplified in order not to obscure the embodiment being described.

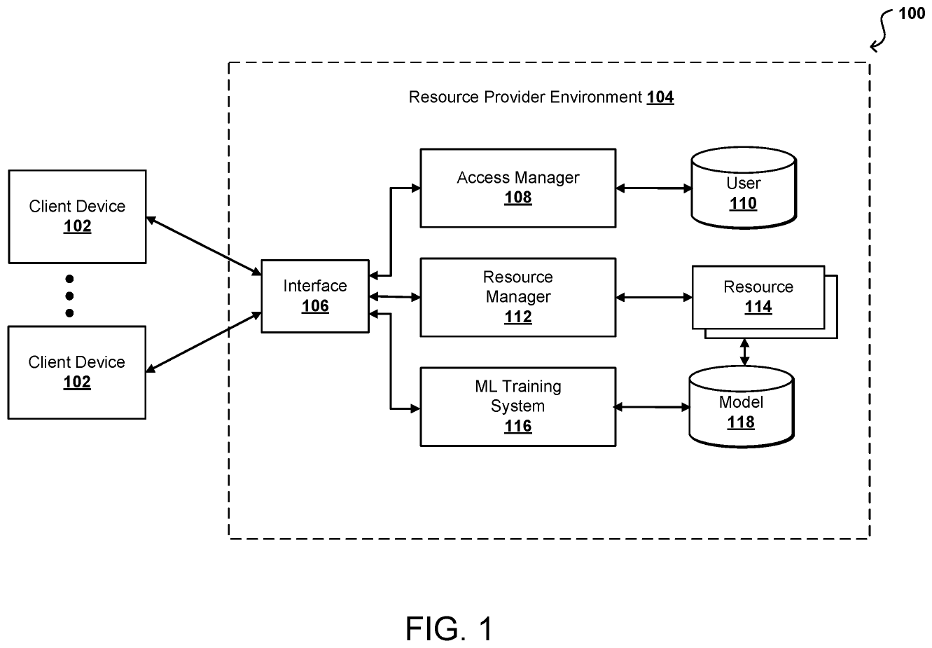

FIG. 1 illustrates an example system 100 that can be used to provide users with access to a variety of different electronic and computing resources, to perform operations as can relate to inferencing using machine learning models. The example system 100 can allow one or client devices 102 to submit requests to a resource provider environment 104 that includes at least one interface 106, an access manager 108, a resource manager 112, and a ML training system 116 that can be used to train, and retrain, one or more machine learning models 118 or model instances. One or more resources 114, such as physical or virtual compute instances, can be allocated to use one or more of these models, or model instances, to perform these operations on behalf of the user in response to the request.

In the embodiment illustrated in FIG. 1, the resource provider environment 104 can include a number of resources 114 that can be made available for use by various users. These resources can include any appropriate computing or electronic resources useful in a networked computing environment, as can relate to physical or virtual servers or compute instances, data repositories, and the like. Users can use various client devices 102 to engage in communications with these resources, such as by sending requests to be received by an interface 106 of the resource provider environment 104, where the interface 106 can direct information for the request within the environment 104 as appropriate. In at least one embodiment, information for a request will be passed to an access manager 108 that can compare information associated with a request against information stored in a user data repository 110, or other such location, to attempt to authenticate a source of the request and determine that the source is authorized to access various resources. Once authentication and authorization are verified, information for the request can be directed to a resource manager 112 to attempt to determine and allocate one or more appropriate resources 114 for serving the request. Once allocated, a request can be directed to an allocated resource instead of first being directed to a resource manager 112.

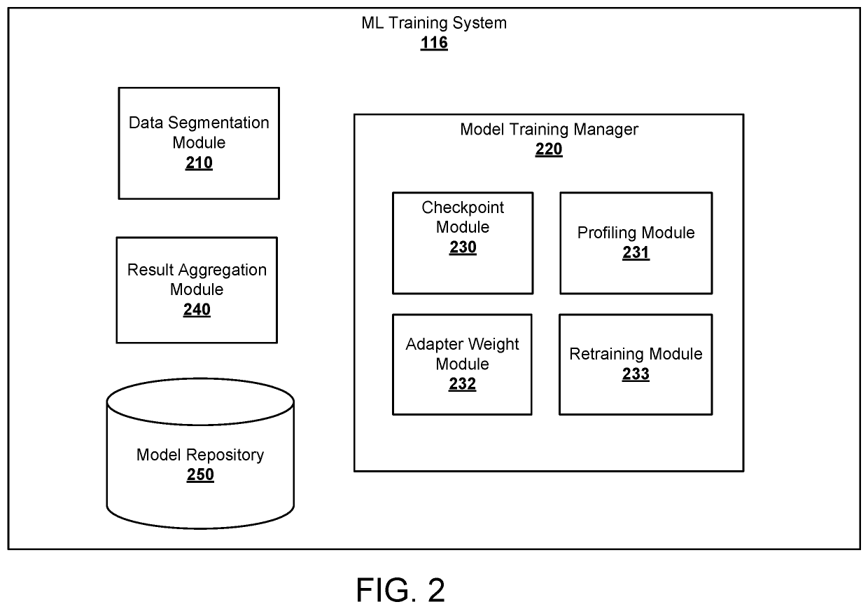

In some embodiments, a user can wish to perform a task that involves removing specific data points related to an individual from one or more systems and machine learning models. For example, the ML training system 116 can receive a request through the interface 106 from the client device 102 to remove data related to one or more individuals from a system. Such a request or instruction can also be received from other entities or sources on behalf of a user as well in at least one embodiment. Information associated with the request can be directed to the ML training system 116 for performing data removal and machine unlearning tasks. For example, a request can be received from the client device 102 to remove data associated with a specific user, the request including an identifier associated with the user (or otherwise usable to identify the data). The ML training system 116 can receive such a request and perform one or more ML training tasks based on the request. Functionalities associated with the ML training system 116 are discussed in greater detail in accordance with FIG. 2.

FIG. 2 illustrates an example ML training system 116 in accordance with at least one embodiment. The ML training system 116 includes a data segmentation module 210 that can partition a dataset into shards and slices, a model training manager 220 that can train instances of a machine learning model on shards and slices of data, a result aggregation module 240 that can determine an aggregated inference output, and a model repository 250 that can store saved models, information related to models, and model parameters.

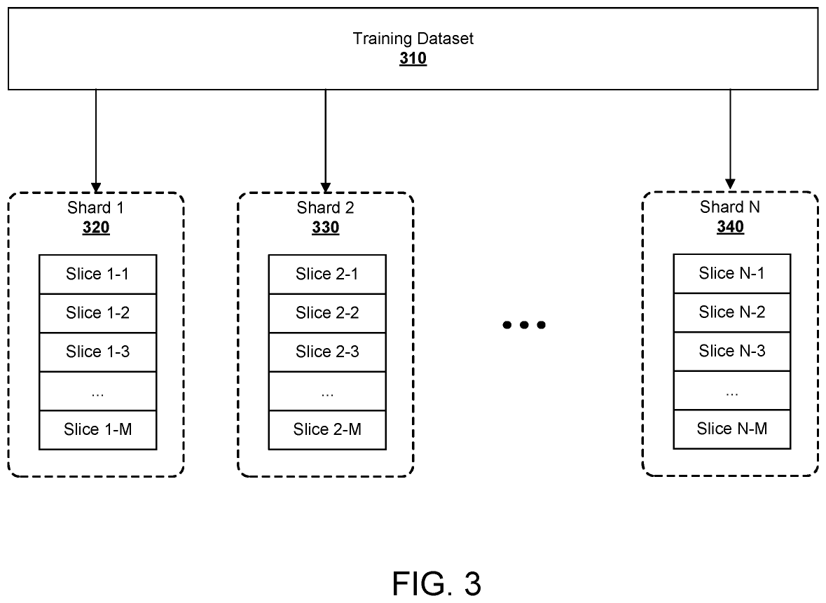

In at least one embodiment, the data segmentation module 210 partitions a dataset into subsets. In at least one embodiment, the data segmentation module 210 can segment a complete training dataset into subsets of data, where the subsets can be referred to as shards. Each shard can contain a non-overlapping portion of data of the training dataset. In one embodiment, all data points from the training dataset are represented in the sharded dataset by including each data point of the training dataset in one of the shards. In at least one embodiment, a shard is further divided into smaller segments or portions (referred to herein as slices), which adds another level of granularity to the dataset, allowing for more precise and efficient handling of data during tasks such as training or retraining of machine learning models. An example illustration of data segmentation is illustrated in FIG. 3.

FIG. 3 provides a visual representation of the segmenting process performed by data segmentation module 210. The data segmentation module 210 can take in a training dataset 310 and proceed to divide the dataset into a number of distinct shards such as shard 1 320, shard 2 330, . . . , shard N 340. Within each of these shards, further division is performed to create one or more slices. In the example illustrated in FIG. 3, the training dataset 310 is segmented into N shards, and each shard is further divided into M slices. In one embodiment, the number of shards and slices can be determined by human input, allowing for manual control over the granularity of the data segmentation. In one embodiment, the determination of the number of shards and slices can be automated, being guided by a machine learning model or statistical model. For example, the data segmentation module 210 can use a machine learning model to analyze factors such as dataset size, complexity, dimension, and the requirements of the training pipeline to optimize the partitioning for efficiency and performance. In the example illustrated in FIG. 3, each shard contains a same number of slices, while in some embodiments, the number of slices within each shard can vary.

Continuing with the discussion of FIG. 2, the model training manager 220 can manage the training and retraining process of machine learning models. In at least one embodiment, the model training manager 220 trains multiple instances of a machine learning model on the partitioned datasets. The model training manager 220 can train a separate instance of a same machine learning model for each shard. Once the model has finished training on the first shard, the instance of the model associated with the first shard is saved to the model repository 250. The model training manager 220 can independently train each shard using a distinct instance of the machine learning model. During inferencing, results produced by these multiple model instances are then forwarded to a result aggregation module 240, which can aggregate and/or otherwise analyze the various inferencing outputs to produce a comprehensive or “consensus” inference result. The model training manager 220 can perform a variety of optimizations to decrease the time taken for retraining and reduce the computational cost. In the example embodiment illustrated in FIG. 2, the model training manager 220 can include a checkpoint module 230 that sets checkpoints during the training process, a profiling module 231 that determines the sequence in which the slices are processed based on user profiles, an adapter weight module 232 that trains the model using adapter weights, and a retraining module 233 that manages retraining upon receiving requests to remove a data point.

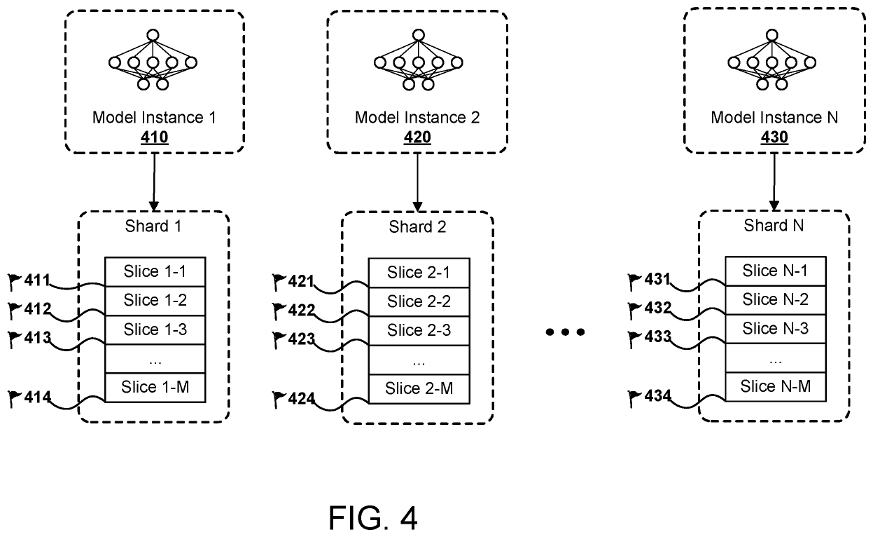

The checkpoint module 230 can set checkpoints during the training process and save the state of the multiple instances of the model at these checkpoints. The checkpoint module 230 can establish checkpoints at different stages during the training of multiple instances of the model. These checkpoints can preserve the state of the model by saving a snapshot of the model throughout the training process. For instance, once a slice of data has been processed and used for training, a checkpoint is established and the current state of the model is saved. The checkpoint module 230 can save a snapshot of the instance of model at the specific point in time, where the snapshot can include information such as model parameters, learned weights and biases, current state of optimizer, learning rate schedule, and any other information that is necessary to resume training from a checkpoint. The checkpoint module 230 can repeat the checkpoint saving action after each slice is processed, ensuring a comprehensive trail of checkpoints throughout the training period. The checkpoint module 230 can save information associated with each checkpoint such as information indicating up to which slice the model has been trained. An illustration of checkpoints is presented in FIG. 4.

FIG. 4 illustrates the process of saving checkpoints for each model instance throughout the training process. The model training manager 220 can train individual model instances such as model instance 1 410, model instance 2 420, . . . , model instance N 430 using respective shards such as shard 1, shard 2, through shard N. Each model instance undergoes training with the data from its corresponding shard, which is composed of M slices of data. The checkpoint module 230 can establish and save a checkpoint after each slice has been used for training. For example, during the training of model instance 1 using data from shard 1, checkpoint 411 is saved post-training of slice 1-1, followed by checkpoint 412 which is saved after the training of slice 1-2. This pattern is maintained across all slices in the shard. At the end of the entire training process, each shard will have contributed M checkpoints. When considering all N model instances, the checkpoint module will have saved a total of M*N checkpoints. In the specific example illustrated in FIG. 4, each shard has a same number of checkpoints (M, in this case). However, it's important to note that the number of checkpoints associated with each shard can vary based on specific needs or objectives. In one embodiment, the checkpoint module 230 can generate the number of checkpoints based on human inputs, which involves human discretion and expertise. In one embodiment, the checkpoint module 230 can generate checkpoints based on automated checkpoint determination. The checkpoint module 230 can leverage machine learning models or statistical models to decide the number of checkpoints. For example, the checkpoint module 230 can utilize machine learning models that analyze the characteristics of the data, estimate the effect of data removal on the model's performance, and predict the frequency of data removal requests. The checkpoint module 230 can use the machine learning models to dynamically adjust the number of checkpoints based on the changing needs of the system, potentially making the process more efficient and scalable.

Continuing with the discussion of model training manager 220 in FIG. 2, the profiling module 231 can adjust the order of slices based on a variety of different factors. This can include, for example, the likelihood of slices containing data points that may need to be removed based upon receiving requests from a user or other such triggers. The profiling module 231 can rearrange slices in a shard such that the slices with the data that is least likely to be subject to an opt-out request, and thus least likely to be involved in subsequent retraining of a model instance, can be placed earlier in the sequence, such as at a higher or earlier slice of a shard. The profiling module 231 can generate a user profile by grouping users into high risk and low risk based on predicted probability of the users opting out. A profile can include other information that can be used to determine placement within a slice or shard, as may relate to the type of information being stored since certain types of data may be subject to specific opt-out regulations or other concerns. A profile can also include an importance value, such as may relate to an importance value for the data, an account for which the data is stored, or a user or customer associated with the account, among other such options. Other factors can be used as well, as may be useful in determining which data should be positioned in a slice that is more or less likely to be involved in a retraining step. In one embodiment, a profiling module 231 can use various approaches to determine a ranking or placement of data within a shard or slice based upon one or more of these or other such factors. For example, an algorithmic approach can be used to determine ranking or placement, or to determine values or clustering useful for making placement decisions. In at least one embodiment, machine learning models and/or statistical analysis can be used to attempt to determine and/or optimize the data placement and slice arrangement. For example, a profiling module 231 can use one or more machine learning models to predict opt-out tendencies based on a variety of factors including user interactions, demographics, historical data, and platform engagement patterns. The profiling module 231 can also use statistical models for predicting the probability of users opting out. For example, the profiling module 231 can simulate the probability using unform distribution, Pareto distribution, inverse Pareto distribution, etc. The profiling module 231 can place data points associated with users who are more probable to opt out to slices closer to the bottom of a shard, such that it would require less retraining if one of these users decides to opt out.

As a specific example, for an online shopping service where users have the freedom to opt out and demand the removal of their data at any time, the profiling module 231 can analyze information such as user behavior patterns, historical data of opt-out tendencies, the duration of a user's association with the service (as newer users exhibit less predictability), and the frequency at which users prefer to receive customized results. The profiling module 231 can use this information to estimate the likelihood of a user opting out. Accordingly, the data points associated with the users who are more likely to opt out could be arranged in the lower slices of a shard to ensure that, in case of an opt-out request, only a minimal number of slices would require retraining, and therefore saving computational resources and time.

In one embodiment, the profiling module 231 can receive instructions to rearrange data points linked to an opt-out risk that exceeds a certain threshold to bottom slices of the shard. In one embodiment, the threshold can be predetermined based on historical data, user behavior patterns, or set manually. In one embodiment, the profiling module 231 can be instructed to identify a certain percentage of slices at the end of the sequence as bottom slices or a bottom segmentation. Data points associated with an opt-out probability exceeding a threshold are placed in the bottom slices. In some embodiments, the data points can be ranked based on the opt-out probability in an ascending order according to their likelihood of being opted-out. Following this rearrangement, slices are then created based on these newly ordered data points, which ensures that slices with a higher likelihood of data removal are positioned later in the sequence and are processed by the machine learning model later in the sequence.

The adapter weight module 232 can use adapter weights for training and save learned adapter weight instead of retraining the entire model. In traditional machine learning model training, the model learns a set of weights (parameters) that map the input data to the correct output. When the model needs to be updated or retrained, typically all of these weights are adjusted, which can be computationally expensive. The adapter weight module 232, on the other hand, can use adapter weights that can be set and/or modified for a pre-trained model so that only a relatively small portion of the overall number of network weights need to be considered, leaving the model's base weights largely unchanged. By only adjusting the adapter weights, the model training manager 220 can update the model to account for changes in the data (e.g., removal of data points) without the need for full-scale retraining. The ability to only consider the adapter weights also provides for memory efficiency as discussed in more detail elsewhere herein, as only a subset of the weight values need to be stored during retraining. When a request is received to remove a data point and the model needs to be updated, the model training manager 220 can consider and update only the adapter weights, without need to consider modification of the base weights during retraining. Instead of saving the entire model state at each checkpoint, the checkpoint module 230 can only store the adjusted adapter weights in the model repository 250, which significantly reduces the amount of storage space required, and allows for a much quicker update process when data points need to be removed. As a specific example, adapter weights can only account for 1-5% of all machine learning model weights. The adapter weight module 232 can only need to retrain and store 1-5% of weights, thereby saving 99-95% of disk storage.

The retraining module 233 can perform actions to retrain an instance of the model upon receiving requests to remove a data point. For example, the retraining module 233 can handle the request to remove a specific data point and identify the data point in its respective shard and slice. The retraining module 233 can remove the data point from the shard and slice and perform retraining of the instance. If the dataset is divided merely into shards without further subdivision into slices, the retraining module 233 only needs to retrain the model instance associated with the modified shard without retraining the other instances (e.g., model instance 2-N). If the shards are segmented into slices, the retraining module 233 can delete the data point from the slice that contains the data point. The retraining module 233 can then retrieve the checkpoint prior to the revised slice and resume the retraining of the remaining slices within the shard from that checkpoint (i.e., most recently saved checkpoint before the revised slice.) To illustrate this using FIG. 4, assuming a data point is removed from slice 1-3 within shard 1, the retraining module 233 can retrain model instance 1 410 starting from checkpoint 412 and resume training using the updated slice 1-3 and progressing onwards, without retraining slice 1-1, slice 1-2, or any other model instance (e.g., model instances 2-N) in this scenario.

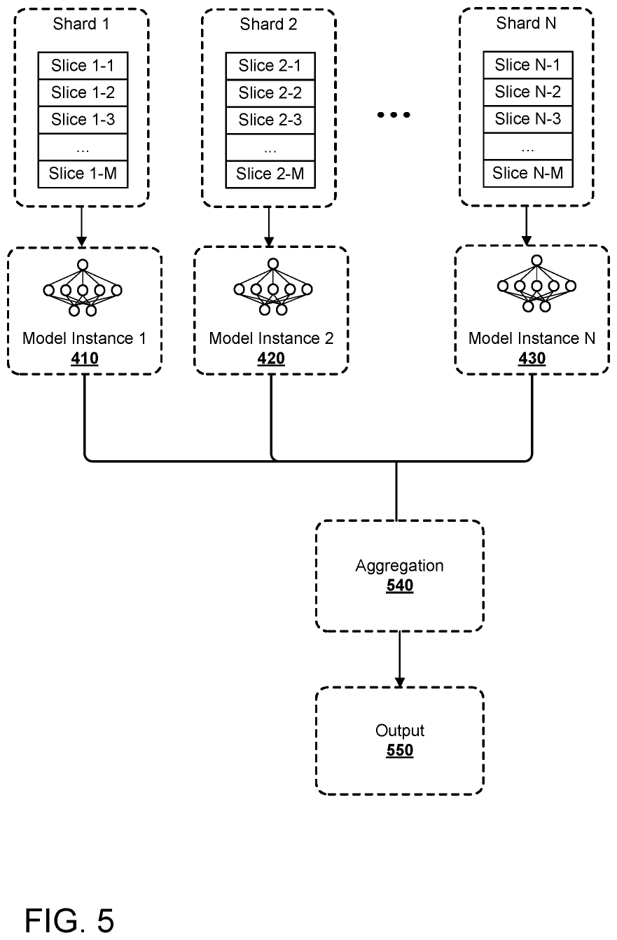

The result aggregation module 240 can determine an aggregated or consensus inference output based on the individual outputs of each model instance. Each of the model instances generates its own inference or prediction, which can be collected and aggregated by the result aggregation module 240. The result aggregation module 240 can generate a consensus output through majority voting. That is, in at least one embodiment the result aggregation module 240 can determine the final, consensus output by identifying which prediction has been made by the majority of the model instances. For instance, if there are five model instances and three of them predict an outcome “X” while the other two infer a different prediction, the result aggregation module 240 could select “X” as the final output because it is the prediction made by the majority of the instances. In some embodiments, the results aggregation module 240 can use other methods for consolidating the outputs. For instance, the result aggregation module 240 can employ a machine learning model designed to handle this specific task. The machine learning model can take inputs such as the reliability or accuracy of each model instance, the nature of the data it was trained on, or other pertinent factors when generating the final results. In one embodiment, the result aggregation module 240 can use a weighted average approach to combine the outputs from the different model instances. In this case, the result aggregation module can assign each output with a weight that represents each model's importance or reliability. The weights can be determined based on various factors such as the size of the shard, the performance of the model on validation data, or even domain-specific considerations. The process of training multiple instances of a machine learning model on partitioned datasets and the subsequent aggregation of the results from these instances are illustrated in FIG. 5.

FIG. 5 illustrates an example process for training multiple instances of a machine learning model on partitioned datasets and aggregating results from the multiple instances. As illustrated in FIG. 5, model instance 1 410 through model instance N 430 are each trained on a distinct shard of data (shard 1-shard N, respectively.) Each model instance is trained individually on its corresponding shard and each model instance can independently produce an output and the outputs are collected by the result aggregation module 240 for aggregation 540. Post-training, each model instance makes its independent prediction or output based on the data it was trained on. The result aggregation module 240 can collect all the individual outputs from the model instances and processes them to produce a final, aggregate output 550. The outputs can be consolidated using a majority vote, machine learning models or using statistical methods.

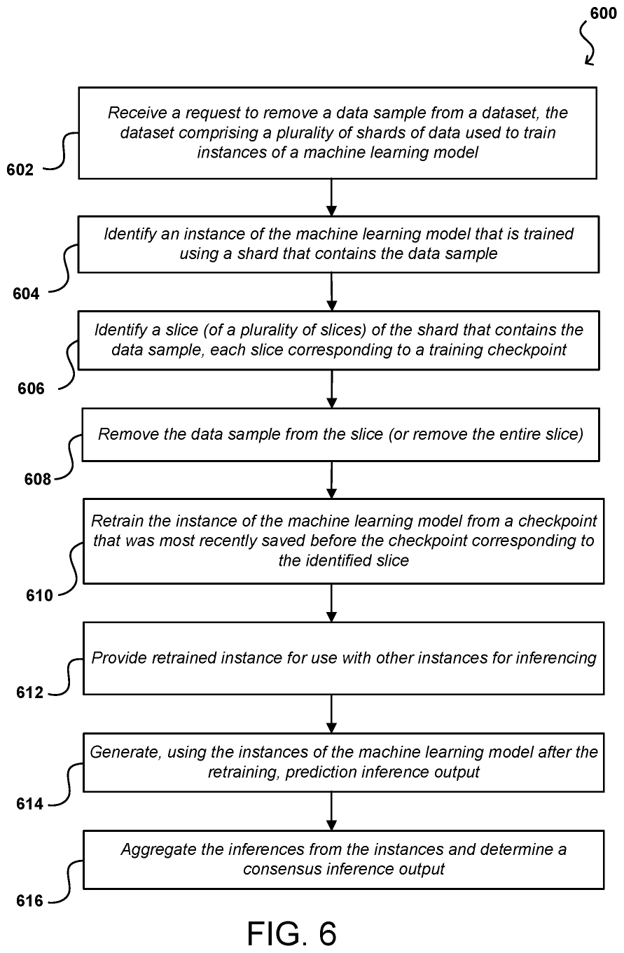

FIG. 6 illustrates an example process for removing data points from a machine learning model. The process 600 illustrated in FIG. 6 can start with a ML training system receiving 602 a request to remove a data sample from a dataset. The dataset can be a training dataset that comprises a plurality of shards, with each shard corresponding to a separate portion of the training dataset. In at least one embodiment, a data segmentation module can segment the full training data set into the plurality of shards, and a model training manager can use the plurality of shards to train a plurality instances of a machine learning model.

A model training manager, or other such component, can identify 604 an instance of the machine learning model that was trained using a shard that contains the data sample(s) to be removed. A slice of the shard that contains the data sample can also be identified 606, where the shard is segmented into a plurality of slices. A checkpoint can have been set during the training process after training using the data in each slice. The data sample can be identified and removed 608 from the training data, such as by removing the data from the respective shard and slice. In some embodiments, this may involve removing an entire data slice. After the data sample is removed and the slice is updated, a retraining module can retrain 610 the corresponding instance of the machine learning model from a checkpoint that was most recently saved before the checkpoint corresponding to the slice from which the data was removed. The retraining can be performed using the corresponding adapter weights, without a need to modify, or store in memory, the base weights during the retraining, which can provide for improved memory and resource efficiency. The retrained instance can then be provided 612 with the other model instances for inferencing. When an inferencing task is to be performed, the instances of the relevant ML model can be used to generate 614 prediction inference output, and these inferences can be aggregated 616 as used to determine a consensus inference output, such as by using majority voting or another such process as discussed or suggested herein.

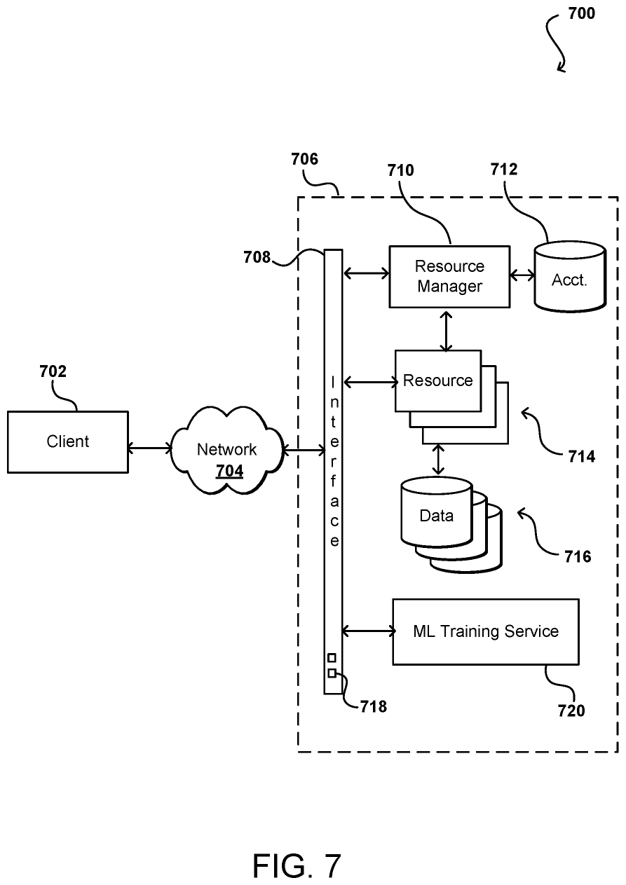

FIG. 7 illustrates an example environment 700 in which aspect of various embodiments can be implemented. Such an environment can be used in some embodiments to provide resource capacity for one or more users, or users of a resource provider, as part of a shared or multi-tenant resource environment. For example, the provider environment 706 can be a cloud environment that can be used to provide cloud-based network connectivity for users, as can be used during disaster recovery or network optimization. The resources can also provide networking functionality for one or more client devices 702, such as personal computers, which can be able to connect to one or more network(s) 704, or can be used to perform network optimization tasks as discussed herein.

In this example a user is able to utilize a client device 702 to submit requests across at least one network 704 to a multi-tenant resource provider environment 706. The client device can include any appropriate electronic device operable to send and receive requests, messages, or other such information over an appropriate network and convey information back to a user of the device. Examples of such client devices include personal computers, tablet computers, smart phones, notebook computers, and the like. The at least one network 704 can include any appropriate network, including an intranet, the Internet, a cellular network, a local area network (LAN), or any other such network or combination, and communication over the network can be enabled via wired and/or wireless connections. The resource provider environment 706 can include any appropriate components for receiving requests and returning information or performing actions in response to those requests. As an example, the provider environment might include Web servers and/or application servers for receiving and processing requests, then returning data, Web pages, video, audio, or other such content or information in response to the request. The environment can be secured such that only authorized users have permission to access those resources.

In various embodiments, a provider environment 706 can include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of resources 714 of one or more types. These types can include, for example, application servers operable to process instructions provided by a user or database servers operable to process data stored in one or more data stores 716 in response to a user request. As known for such purposes, a user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 714 can submit a request that is received to an interface layer 708 of the provider environment 706. The interface layer can include application programming interfaces (APIs) or other exposed interfaces 718 enabling a user to submit requests to the provider environment. The interface layer 708 in this example can also include other components as well, such as at least one Web server, routing components, load balancers, and the like. When a request to provision a resource is received to the interface layer 708, information for the request can be directed to a resource manager 710 or other such system, service, or component configured to manage user accounts and information, resource provisioning and usage, and other such aspects. A resource manager 710 receiving the request can perform tasks such as to authenticate an identity of the user submitting the request, as well as to determine whether that user has an existing account with the resource provider, where the account data can be stored in at least one data store 712 in the provider environment. A user can provide any of various types of credentials in order to authenticate an identity of the user to the provider. These credentials can include, for example, a username and password pair, biometric data, a digital signature, or other such information. The provider can validate this information against information stored for the user. If a user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

In at least one embodiment, resources made available for use by a client device 702 can include services provided by the ML training service 720. The client device 702 can send a request to the ML training service 720 to remove specific data from a system. The ML training service 720, upon receiving the request, can perform various ML training tasks to remove the requested data from machine learning models.

Once a user (or other requestor) is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identity, specific address, or other such information that can enable the client device 702 to communicate with an allocated resource without having to communicate with the resource manager 710, at least until such time as a relevant aspect of the user account changes, the user is no longer granted access to the resource, or another such aspect changes. In some embodiments, a user can run a host operating system on a physical resource, such as a server, which can provide that user with direct access to hardware and software on that server, providing near full access and control over that resource for at least a determined period of time. Access such as this is sometimes referred to as “bare metal” access as a user provisioned on that resource has access to the physical hardware.

A resource manager 710 (or another such system or service) in this example can also function as a virtual layer of hardware and software components that handles control functions in addition to management actions, as can include provisioning, scaling, replication, etc. The resource manager can utilize dedicated APIs in the interface layer 708, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 708 in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

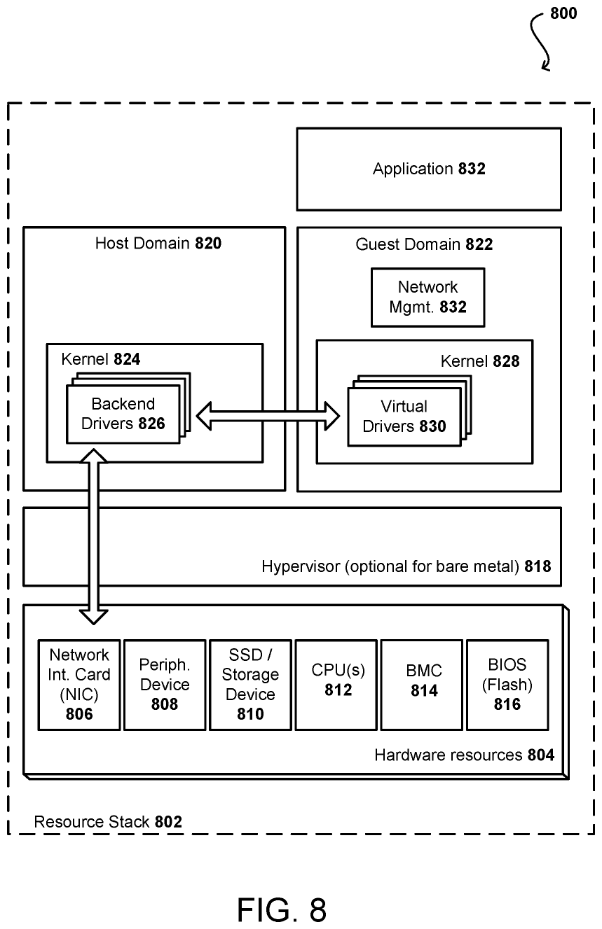

FIG. 8 illustrates an example resource stack 802 of a physical resource 800 that can be utilized in accordance with various embodiments, such as can be provided as part of a provider environment such as that illustrated in FIG. 7. When performing tasks, such as security-related tasks using a secure data application 832, for example, such resources can include components such as CPUs 812 for executing code to perform these tasks, NICs 806 for communicating network traffic, and memory for storing instructions and networking data. In some embodiments, an entire machine can be allocated for these tasks, or only a portion of the machine, such as to allocate a portion of the resources as a virtual machine in a guest domain 822 that can perform at least some of these tasks.

Such a resource stack 802 can be used to provide an allocated environment for a user (or user of a resource provider) having an operating system provisioned on the resource. In accordance with the illustrated embodiment, the resource stack 802 includes a number of hardware resources 804, such as one or more central processing units (CPUs) 812; solid state drives (SSDs) or other storage devices 810; a network interface card (NIC) 806, one or more peripheral devices (e.g., a graphics processing unit (GPU), etc.) 808, a BIOS implemented in flash memory 816, and a baseboard management controller (BMC) 814, and the like. In some embodiments, the hardware resources 804 reside on a single computing device (e.g. chassis). In other embodiments, the hardware resources can reside on multiple devices, racks, chassis, and the like. Running on top of the hardware resources 804, a virtual resource stack can include a virtualization layer such as a hypervisor 818 for a Xen-based implementation, a host domain 820, and potentially also one or more guest domains 822 capable of executing at least one application 832. The hypervisor 818, if utilized for a virtualized environment, can manage execution of the one or more guest operating systems and allow multiple instances of different operating systems to share the underlying hardware resources 804. Conventionally, hypervisors are installed on server hardware, with the function of running guest operating systems, where the guest operating systems themselves act as servers.

In accordance with an embodiment, a hypervisor 818 can host a number of domains (e.g., virtual machines), such as the host domain 820 and one or more guest domains 822. In one embodiment, the host domain 820 (e.g., the Dom-0) is the first domain created and helps virtualize hardware resources and manage all of the other domains running on the hypervisor 818. For example, the host domain 820 can manage the creating, destroying, migrating, saving, or restoring the one or more guest domains 822 (e.g., the Dom-U). In accordance with various embodiments, the hypervisor 818 can control access to the hardware resources such as the CPU, input/output (I/O) memory, and hypervisor memory.

A guest domain 822 can include one or more virtualized or para-virtualized drivers 830 and the host domain can include one or more backend device drivers 826. When the operating system (OS) kernel 828 in the guest domain 822 wants to invoke an I/O operation, the virtualized driver 830 can perform the operation by way of communicating with the backend device driver 826 in the host domain 820. When the guest driver 830 wants to initiate an I/O operation (e.g., to send out a network packet), a guest kernel component can identify which physical memory buffer contains the packet (or other data) and the guest driver 830 can either copy the memory buffer to a temporary storage location in the kernel for performing I/O or obtain a set of pointers to the memory pages that contain the packet(s). In at least one embodiment, these locations or pointers are provided to the backend driver 826 of the host kernel 824 which can obtain access to the data and communicate it directly to the hardware device, such as the NIC 806 for sending the packet over the network.

It should be noted that the resource stack 802 illustrated in FIG. 8 is only one possible example of a set of resources that is capable of providing a virtualized computing environment and that the various embodiments described herein are not necessarily limited to this particular resource stack. In some embodiments, the guest domain 822 can have substantially native or “bare metal” access to the NIC 806 hardware, for example as provided by device assignment technology based on an IO Memory Management Unit (IO-MMU) device mapping solution like Intel VT-D. In such an implementation, there can be no virtualization layer (e.g., Hypervisor) present. The host domain, or OS, can then be provided by the user, with no guest domains utilized. Other technologies, such Single Root IO Virtualization (SR-IOV), can provide similar “bare metal” functionality to guest domains for only certain functionality of the devices. In general, in various other embodiments, the resource stack can comprise different virtualization strategies, hardware devices, operating systems, kernels, domains, drivers, hypervisors and other resources.

In compute servers, a Board Management Controller (BMC) 814 can maintain a list of events that have occurred in the system, referred to herein as a system event log (SEL). In at least one embodiment, the BMC 814 can receive system event logs from the BIOS 816 on the host processor. The BIOS 816 can provide data for system events over an appropriate interface, such as an I²C interface, to the BMC using an appropriate protocol, such as an SMBus System Interface (SSIF) or KCS interface over LPC. As mentioned, an example of a system event log event from BIOS includes an uncorrectable memory error, indicating a bad RAM stick. In at least some embodiments, system event logs recorded by BMCs on various resources can be used for purposes such as to monitor server health, including triggering manual replacement of parts or instance degrade when SELs from the BIOS indicate failure.

As mentioned, in a virtualized environment the hypervisor 818 can prevent the guest operating system, or guest domain 822, from sending such system event log data to the BMC 814. In the case of bare metal access without such a hypervisor, however, user instances can have the ability to send data for system event that spoof events from the BIOS 816. Such activity could lead to compromised bare metal instances being prematurely degraded due to fake system event data produced by the user OS.

In at least one embodiment, however, there will be portions of the physical resource 800 that will be inaccessible to the user OS. This can include, for example, at least a portion of BIOS memory 816. BIOS memory 816 in at least one embodiment is volatile memory such that any data stored to that memory will be lost in the event of a reboot or power down event. The BIOS can keep at least a portion of host memory unmapped, such that it is not discoverable by a host OS. As mentioned, data such as a secret token can be stored to BIOS memory 816 at boot time, before a user OS is executing on the resource. Once the user OS is executing on the resource, that OS will be prevented from accessing that secret token in BIOS memory 816. In at least one embodiment, this secret token (or other stored secret) can be provided to the BMC 814 when adding system event log events, whereby the BMC 814 can confirm that the event is being sent by the BIOS 816 and not by the user OS.

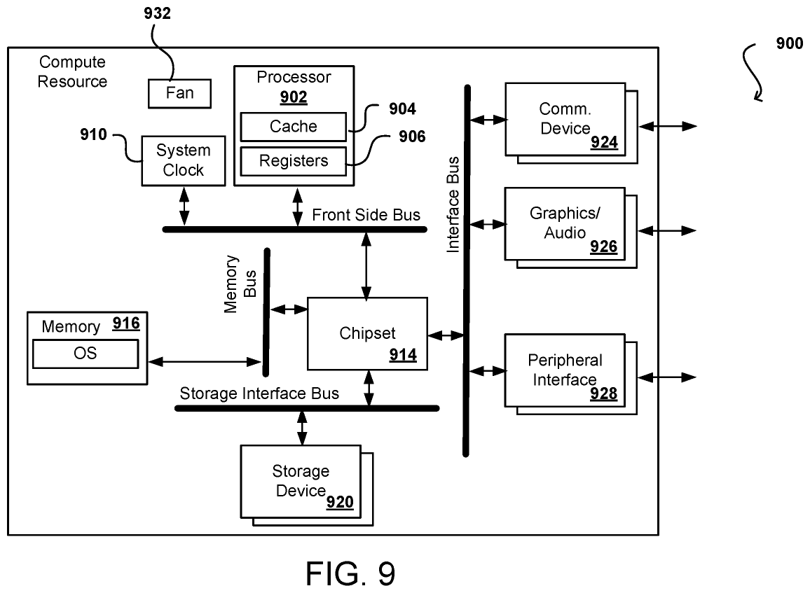

Computing resources, such as servers, smartphones, or personal computers, will generally include at least a set of standard components configured for general purpose operation, although various proprietary components and configurations can be used as well within the scope of the various embodiments. As mentioned, this can include client devices for transmitting and receiving network communications, or servers for performing tasks such as network analysis and rerouting, among other such options. FIG. 9 illustrates components of an example computing resource 900 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 900 (e.g., a desktop or network server) will have one or more processors 902, such as central processing units (CPUs), graphics processing units (GPUs), and the like, that are electronically and/or communicatively coupled with various components using various buses, traces, and other such mechanisms. A processor 902 can include memory registers 906 and cache memory 904 for holding instructions, data, and the like. In this example, a chipset 914, which can include a northbridge and southbridge in some embodiments, can work with the various system buses to connect the processor 902 to components such as system memory 916, in the form or physical RAM or ROM, which can include the code for the operating system as well as various other instructions and data utilized for operation of the computing device. The computing device can also contain, or communicate with, one or more storage devices 920, such as hard drives, flash drives, optical storage, and the like, for persisting data and instructions similar, or in addition to, those stored in the processor and memory. The processor 902 can also communicate with various other components via the chipset 914 and an interface bus (or graphics bus, etc.), where those components can include communications devices 924 such as cellular modems or network cards, media components 926, such as graphics cards and audio components, and peripheral interfaces 928 for connecting peripheral devices, such as printers, keyboards, and the like. At least one cooling fan 932 or other such temperature regulating or reduction component can also be included as well, which can be driven by the processor or triggered by various other sensors or components on, or remote from, the device. Various other or alternative components and configurations can be utilized as well as known in the art for computing devices.

At least one processor 902 can obtain data from physical memory 916, such as a dynamic random access memory (DRAM) module, via a coherency fabric in some embodiments. It should be understood that various architectures can be utilized for such a computing device, which can include varying selections, numbers, and arguments of buses and bridges within the scope of the various embodiments. The data in memory can be managed and accessed by a memory controller, such as a DDR controller, through the coherency fabric. The data can be temporarily stored in a processor cache 904 in at least some embodiments. The computing device 900 can also support multiple I/O devices using a set of I/O controllers connected via an I/O bus. There can be I/O controllers to support respective types of I/O devices, such as a universal serial bus (USB) device, data storage (e.g., flash or disk storage), a network card, a peripheral component interconnect express (PCIe) card or interface 928, a communication device 924, a graphics or audio card 926, and a direct memory access (DMA) card, among other such options. In some embodiments, components such as the processor, controllers, and caches can be configured on a single card, board, or chip (i.e., a system-on-chip implementation), while in other embodiments at least some of the components can be located in different locations, etc.

An operating system (OS) running on the processor 902 can help to manage the various devices that can be utilized to provide input to be processed. This can include, for example, utilizing relevant device drivers to enable interaction with various I/O devices, where those devices can relate to data storage, device communications, user interfaces, and the like. The various I/O devices will typically connect via various device ports and communicate with the processor and other device components over one or more buses. There can be specific types of buses that provide for communications according to specific protocols, as can include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device can be used, for example, as a server in a server farm or data warehouse. Server computers often have a need to perform tasks outside the environment of the CPU and main memory (i.e., RAM). For example, the server can need to communicate with external entities (e.g., other servers) or process data using an external processor (e.g., a General Purpose Graphical Processing Unit (GPGPU)). In such cases, the CPU can interface with one or more I/O devices. In some cases, these I/O devices can be special-purpose hardware designed to perform a specific role. For example, an Ethernet network interface controller (NIC) can be implemented as an application specific integrated circuit (ASIC) comprising digital logic operable to send and receive packets.

In an illustrative embodiment, a host computing device is associated with various hardware components, software components and respective configurations that facilitate the execution of I/O requests. One such component is an I/O adapter that inputs and/or outputs data along a communication channel. In one aspect, the I/O adapter device can communicate as a standard bridge component for facilitating access between various physical and emulated components and a communication channel. In another aspect, the I/O adapter device can include embedded microprocessors to allow the I/O adapter device to execute computer executable instructions related to the implementation of management functions or the management of one or more such management functions, or to execute other computer executable instructions related to the implementation of the I/O adapter device. In some embodiments, the I/O adapter device can be implemented using multiple discrete hardware elements, such as multiple cards or other devices. A management controller can be configured in such a way to be electrically isolated from any other component in the host device other than the I/O adapter device. In some embodiments, the I/O adapter device is attached externally to the host device. In some embodiments, the I/O adapter device is internally integrated into the host device. Also in communication with the I/O adapter device can be an external communication port component for establishing communication channels between the host device and one or more network-based services or other network-attached or direct-attached computing devices. Illustratively, the external communication port component can correspond to a network switch, sometimes known as a Top of Rack (“TOR”) switch. The I/O adapter device can utilize the external communication port component to maintain communication channels between one or more services and the host device, such as health check services, financial services, and the like.

The I/O adapter device can also be in communication with a Basic Input/Output System (BIOS) component. The BIOS component can include non-transitory executable code, often referred to as firmware, which can be executed by one or more processors and used to cause components of the host device to initialize and identify system devices such as the video display card, keyboard and mouse, hard disk drive, optical disc drive and other hardware. The BIOS component can also include or locate boot loader software that will be utilized to boot the host device. For example, in one embodiment, the BIOS component can include executable code that, when executed by a processor, causes the host device to attempt to locate Preboot Execution Environment (PXE) boot software. Additionally, the BIOS component can include or takes the benefit of a hardware latch that is electrically controlled by the I/O adapter device. The hardware latch can restrict access to one or more aspects of the BIOS component, such controlling modifications or configurations of the executable code maintained in the BIOS component. The BIOS component can be connected to (or in communication with) a number of additional computing device resources components, such as processors, memory, and the like. In one embodiment, such computing device resource components can be physical computing device resources in communication with other components via the communication channel. The communication channel can correspond to one or more communication buses, such as a shared bus (e.g., a front side bus, a memory bus), a point-to-point bus such as a PCI or PCI Express bus, etc., in which the components of the bare metal host device communicate. Other types of communication channels, communication media, communication buses or communication protocols (e.g., the Ethernet communication protocol) can also be utilized. Additionally, in other embodiments, one or more of the computing device resource components can be virtualized hardware components emulated by the host device. In such embodiments, the I/O adapter device can implement a management process in which a host device is configured with physical or emulated hardware components based on a variety of criteria. The computing device resource components can be in communication with the I/O adapter device via the communication channel. In addition, a communication channel can connect a PCI Express device to a CPU via a northbridge or host bridge, among other such options.

In communication with the I/O adapter device via the communication channel can be one or more controller components for managing hard drives or other forms of memory. An example of a controller component can be a SATA hard drive controller. Similar to the BIOS component, the controller components can include or take the benefit of a hardware latch that is electrically controlled by the I/O adapter device. The hardware latch can restrict access to one or more aspects of the controller component. Illustratively, the hardware latches can be controlled together or independently. For example, the I/O adapter device can selectively close a hardware latch for one or more components based on a trust level associated with a particular user. In another example, the I/O adapter device can selectively close a hardware latch for one or more components based on a trust level associated with an author or distributor of the executable code to be executed by the I/O adapter device. In a further example, the I/O adapter device can selectively close a hardware latch for one or more components based on a trust level associated with the component itself. The host device can also include additional components that are in communication with one or more of the illustrative components associated with the host device. Such components can include devices, such as one or more controllers in combination with one or more peripheral devices, such as hard disks or other storage devices. Additionally, the additional components of the host device can include another set of peripheral devices, such as Graphics Processing Units (“GPUs”). The peripheral devices and can also be associated with hardware latches for restricting access to one or more aspects of the component. As mentioned above, in one embodiment, the hardware latches can be controlled together or independently.

As discussed, different approaches can be implemented in various environments in accordance with the described embodiments. As will be appreciated, although a network- or Web-based environment is used for purposes of explanation in several examples presented herein, different environments can be used, as appropriate, to implement various embodiments. Such a system can include at least one electronic client device, which can include any appropriate device operable to send and receive requests, messages or information over an appropriate network and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which can be chained or otherwise configured, which can interact to perform tasks such as obtaining data from an appropriate data store. As used herein, the term “data store” refers to any device or combination of devices capable of storing, accessing and retrieving data, which can include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which can be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that can need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) can also be capable of executing programs or scripts in response requests from user devices, such as by executing one or more Web applications that can be implemented as one or more scripts or programs written in any programming language, such as Java®, C, C # or C++ or any scripting language, such as Perl, Python or TCL, as well as combinations thereof. The server(s) can also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers can include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (SAN) familiar to those skilled in the art. Similarly, any necessary files for performing the functions attributed to the computers, servers or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system can also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments can have numerous variations from that described above. For example, customized hardware might also be used and/or particular elements might be implemented in hardware, software (including portable software, such as applets) or both. Further, connection to other computing devices such as network input/output devices can be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes can be made thereunto without departing from the broader spirit and scope of the invention as set forth in the claims.

What is claimed is:

1. A computer-implemented method, comprising:
receiving a request to remove a data sample from a dataset, the dataset comprising a plurality of shards each corresponding to a portion of the dataset, training data in the plurality of shards used to train a respective plurality of instances of a language model;
identifying an instance of the language model that is trained using a shard that contains the data sample;
identifying a slice of the shard that contains the data sample, the shard comprising a plurality of slices of the training data each corresponding to a checkpoint set during training;
removing the data sample from the identified slice of the dataset;
retraining the identified instance of the language model using a set of adapter weights and starting from the checkpoint that was most recently set before the identified instance was trained using the data in the slice; and
providing the retrained instance with the other instances, of the plurality of instances of the language model, to generate a plurality of inferences to be used to generate a consensus inference output.

2. The computer-implemented method of claim 1, wherein generating the updated inference output further comprising:
determining the consensus inference output based on a majority vote based on the plurality of inferences.

3. The computer-implemented method of claim 1, wherein the data samples are positioned in the slices of a shard of the dataset based at least in part on a likelihood that a request will be received to remove the data samples from the dataset.

4. The computer-implemented method of claim 1, wherein the plurality of instances of the language model are trained using a set of the adapter weights and a set of base weights.

5. The computer-implemented method of claim 4, wherein a subset of the adapter weights is stored for each slice and the instance of the language model is retrained using a respective set of the adapter weights without modifying the base weights.

6. A computer-implemented method, comprising:
receiving a request to remove a data sample from a dataset used to train a plurality instances of a language model, the plurality of instances trained using respective portions of the dataset;
identifying an instance of the language model that was trained using a portion of the dataset including the data sample;
removing the data sample from the dataset;
retraining the identified instance of the language model using the portion of the dataset with the data sample removed; and
providing the retrained instance for use in the plurality of instances to generate inferences to be aggregated into a single inference output.

7. The computer-implemented method of claim 6, wherein each portion of the dataset corresponds to a shard and each shard comprises a plurality of slices, each slice comprising a portion of data samples in a respective shard.

8. The computer-implemented method of claim 7, wherein generating the updated inference output further comprises:
generating an inference for each shard of the plurality of shards using a respective instance of the plurality of instances; and
determining the single inference output based on a majority vote from the inferences.

9. The computer-implemented method of claim 7, wherein each slice corresponds to a checkpoint set after training of a respective instance of the language model.

10. The computer-implemented method of claim 9, further comprising:
determining a slice that contains the data sample to be removed, the slice corresponding to a checkpoint;
removing the data sample from the slice; and
retraining the instance of the language model from a checkpoint that was most recently set before the slice was used to train the identified instance.

11. The computer-implemented method of claim 7, wherein the data samples are positioned in the slices of a shard of the dataset based on a determined ranking of the data samples.

12. The computer-implemented method of claim 11 wherein data samples with a higher likelihood of being removed from the dataset are placed in slices used for training after data samples with a lower likelihood of being removed.

13. The computer-implemented method of claim 11 wherein data samples associated with a higher determined importance are placed in slices used for training before data samples associated with a lower determined importance.

14. The computer-implemented method of claim 6, wherein the language model is trained based on a set of adapter weights and a set of base weights.

15. The computer-implemented method of claim 14, wherein a respective subset of the adapter weights is stored for each shard, and wherein only the respective subset of the adapter weights is modified during the retraining.

16. A system, comprising:
a processor; and
a memory device including instructions that, when executed by the processor, cause the processor to:
receive a request to remove a data sample from a dataset used to train a plurality instances of a machine learning model, the plurality of instances trained using respective portions of the dataset;
identify an instance of the machine learning model that was trained using a portion of the dataset including the data sample;
remove the data sample from the dataset;
retrain the identified instance of the machine learning model using a set of adapter weights and the portion of the dataset with the data sample removed; and
provide the retrained instance for use in the plurality of instances to generate inferences to be aggregated into a single inference output.

17. The system of claim 16, wherein each portion of the dataset corresponds to a shard and each shard comprises a plurality of slices, each slice comprising a portion of data samples in a respective shard.

18. The system of claim 17, wherein the instructions, when executed by the processor, further cause the processor to:
generate an inference for each shard of the plurality of shards using a respective instance of the plurality of instances; and
determine the single inference output based on a majority vote from the inferences.

19. The system of claim 17, wherein each slice corresponds to a checkpoint set after training of a respective instance of the machine learning model, and wherein the instructions, when executed by the processor, further cause the processor to:
determine a slice that contains the data sample to be removed, the slice corresponding to a checkpoint;
remove the data sample from the slice; and
retrain the instance of the machine learning model from a checkpoint that was most recently set before the slice was used to train the identified instance.

20. The system of claim 16, wherein the machine learning model is trained based on a set of adapter weights and a set of base weights, wherein a respective subset of the adapter weights is stored for each shard, and wherein only the respective subset of the adapter weights is modified during the retraining.
